(19) United States
(12) Patent Application Publication
(10) Pub. No.: US 2013/0082651 A1
(43) Pub. Date: Apr. 4, 2013

(54) APPARATUS AND METHOD FOR WIRELESS CHARGING

(71) Applicant: Samsung Electronics Co., Ltd., Suwon-si (KR)

(72) Inventors: Se-Ho PARK, Suwon-si (KR); Young-Min LEE, Yongin-si (KR)

(73) Assignee: Samsung Electronics Co., Ltd., Suwon-si (KR)

(21) Appl. No.: 13/628,737

(22) Filed: Sep. 27, 2012

(30) Foreign Application Priority Data
Sep. 30, 2011 (KR) 10-2011-0099661
Sep. 25, 2012 (KR) 10-2012-0106501

(51) Int. Cl. H02J 7/00

(52) U.S. Cl. 320/108; 320/137

(57) ABSTRACT

Methods and apparatus are provided for wireless charging. Wireless power is supplied by a wireless power supply apparatus and is received at a wireless power reception apparatus. Wireless charging is performed by the wireless power reception apparatus. It is determined whether a human body is approaching while the wireless power reception power apparatus is receiving the wireless power. The wireless charging is interrupted, when it is determined that the human body is approaching.

### PRIORITY

This application claims priority under 35 U.S.C. §119(a) to Korean Application Serial No. 10-2011-0099661, which was filed in the Korean Intellectual Property Office on Sep. 30, 2011, and to Korean Application Serial No. 10-2012-0106501, which was filed in the Korean Intellectual Property Office on Sep. 25, 2012, the contents of which are incorporated herein by reference.

### BACKGROUND OF THE INVENTION

1. Field of the Invention

The present invention relates generally to an apparatus and a method for wireless charging, and more particularly, to an apparatus and a method for wireless charging using a wireless power reception apparatus that wirelessly receives power and a wireless power supply apparatus that wirelessly provides power.

2. Description of the Related Art

Various technologies for providing power to portable electronic products have been developed. Particularly, technologies that provide power through a power line have mainly been used in the past. However, a wireless power transmission technology that is capable of wirelessly supplying power has been developed recently.

The wireless power transmission technology is capable of wirelessly supplying electric power, anytime and anywhere, without a power line, such as, for example, an electric wire. The wireless power transmission technology is a core technology for electronic equipment wireless charging, electric car wireless power supply and wireless charging, remote place wireless power supply, ubiquitous wireless sensor power supply, or the like. The wireless power transmission technology is attracting attention as a substitute for the conventional power source supply and charging scheme using an electric wire.

Wireless charging technology includes, for example, an electromagnetic induction scheme, a resonance scheme using a resonance, and a Radio Frequency (RF)/Micro Wave Radiation scheme, which converts electrical energy into a microwave and transmits the microwave. The electromagnetic induction scheme is most commonly used.

A wireless charging method using electromagnetic induction transmits power between a first coil and a second coil. When a magnet is moved in a coil, an induced current occurs. Using this induced current, a magnetic field is generated in a transmitter, or, specifically, a wireless power supply apparatus. Further, in a receiver, or a wireless power reception apparatus, a current is induced according to a change of the magnetic field, so as to make an electric energy. A power reception apparatus performs wireless charging by charging a battery with this electric energy.

The wireless charging technology has been limited to uses including, for example, an electric shaver or an electric toothbrush. However, with the development of a better resonance scheme, wireless charging through electromagnetic induction has been introduced to various equipment, such as, for example, mobile phones, televisions, or the like.

Since a wireless charging apparatus, as described above, generates a powerful magnetic field in a wireless power supply apparatus in order to supply a wireless power to a wireless power reception apparatus, the wireless charging apparatus may have a harmful effect on a human body that is in close proximity.

For example, when wireless charging is performed in a smart phone using a wireless charging pad, if a user moves a part of his/her body, such as a hand, to approach the wireless charging pad and the smart phone in order to operate a smart phone, a powerful magnetic field generated by the wireless charging pad may have a harmful effect on the user's body.

### SUMMARY OF THE INVENTION

The present invention has been made to address at least the above problems and/or disadvantages and to provide at least the advantages described below. Accordingly, an aspect of the present invention provides an apparatus and a method for wireless charging, which can prevent a human body from being exposed to a magnetic field generated during wireless charging.

Another aspect of the present invention provides an apparatus and a method for wireless charging, which can detect an approaching human body during wireless charging and interrupt generation of a magnetic field by wireless charging when a human body approaches.

In accordance with an aspect of the present invention, a method is provided for wireless charging. Wireless power is received at a wireless power reception apparatus and wireless charging is performed by the wireless power reception apparatus. It is determined whether a human body is approaching the wireless power reception apparatus while the wireless power reception power apparatus is receiving the wireless power. The wireless charging is interrupted, when it is determined that the human body is approaching the wireless power reception apparatus.

In accordance with another aspect of the present invention, a method of wireless charging is provided. Wireless power is supplied by a wireless power supply apparatus. It is determined whether a human body is approaching the wireless supply reception apparatus while the wireless power supply apparatus is supplying the wireless power. The wireless charging is interrupted, when it is determined that the human body is approaching the wireless power supply apparatus.

In accordance with another aspect of the present invention, an apparatus for wireless charging is provided. The apparatus includes a power receiver for receiving a supply power through resonance with a wireless power supply apparatus in a same frequency. The apparatus also includes a battery unit that is charged using the supply power. The apparatus additionally includes a switching unit disposed between the power receiver and the battery unit for interrupting a wireless charging operation of the battery unit. The apparatus further includes a human body proximity detector for determining whether a human body is approaching the apparatus. The apparatus also includes a controller for wirelessly controlling the power receiver to wirelessly receive power from the power supply apparatus, and for controlling the switching unit to interrupt the wireless charging operation when it is determined that the human body is approaching the apparatus.

In accordance with another aspect of the present invention, an apparatus is provided for wireless charging. The apparatus includes a power supplier for supplying power to a wireless power reception apparatus by resonance in a same frequency. The apparatus also includes a human proximity detector for determining whether a human body is approaching the apparatus. The apparatus further includes a controller for controlling the power supplier to supply power to the wireless power reception apparatus, and for controlling an interruption in supplying the power when it is determined that the human body is approaching the apparatus.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a wireless charging apparatus and a magnetic field generated from the wireless charging apparatus, according to an embodiment of the present invention;

FIG. 2 is a block diagram illustrating a construction of a wireless charging apparatus, according to an embodiment of the present invention;

FIG. 3 is a flowchart illustrating a method of receiving wireless power at a portable terminal, according to an embodiment of the present invention; and

FIG. 4 is a flowchart illustrating a method of supplying wireless power from a charging pad, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

A wireless charging apparatus, according to an embodiment of the present invention, may apply to a wireless power reception apparatus and a wireless power supply apparatus. The wireless charging apparatus, according to an embodiment of the present invention, may be employed in portable electronic device wireless charging, electric vehicle wireless power supply and wireless charging, remote place wireless power supply, ubiquitous wireless sensor power supply, or the like, and may be embodied as any apparatus that performs wireless power supply and reception. According to an embodiment of the present invention, an apparatus for providing wireless power is referred to as a wireless power supply apparatus, and an apparatus for receiving wireless power is referred to as a wireless power reception apparatus.

In a wireless charging apparatus, according to an embodiment of the present invention, a wireless power reception apparatus determines whether a human body approaches the wireless power reception apparatus during wireless charging. When the human body approaches, the wireless power reception apparatus stops wireless charging. Further, in a wireless charging apparatus, according to an embodiment of the present invention, a wireless power supply apparatus determines whether a human body approaches the wireless power reception apparatus during wireless charging. When the human body approaches, the wireless power supply apparatus stops the wireless power supply. Therefore, according to an embodiment of the present invention, it is possible to prevent a human body from being exposed to a magnetic field generated through the execution of wireless charging.

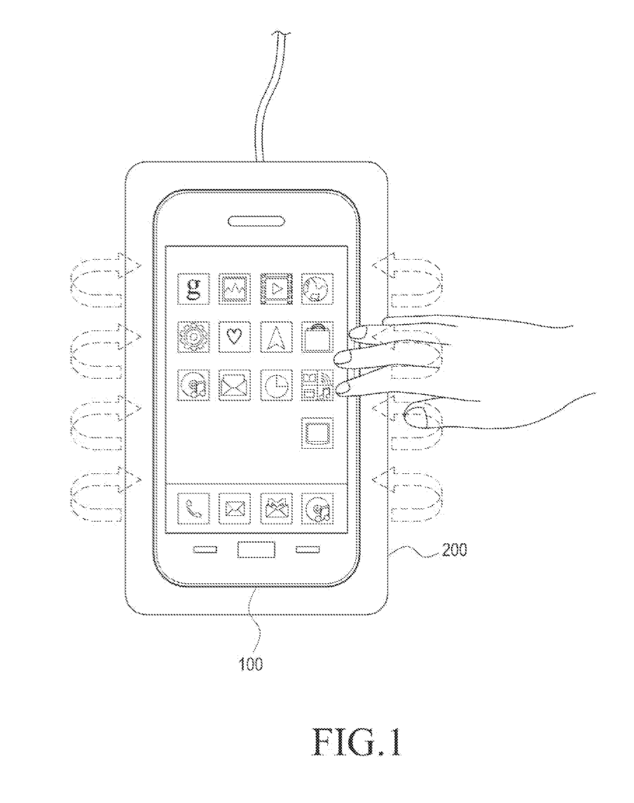

Hereinafter, the wireless charging apparatus of the present invention is described in greater detail below. FIG. 1 is a diagram illustrating a wireless charging apparatus and a magnetic field generated by the wireless charging apparatus, according to an embodiment of the present invention. FIG. 1 illustrates a wireless power reception apparatus 100 and a wireless power supply apparatus 200. The wireless power reception apparatus 100 may be a portable electronic device, such as, for example, a portable terminal, and the wireless power supply apparatus 200 may be an apparatus capable of supplying wireless power, such as, for example, a charging pad. The following description of the present invention is based on an embodiment in which the wireless power supply apparatus 200 and the wireless power reception apparatus 100 are embodied as a charging pad 200 and a portable terminal 100, respectively.

FIG. 1 illustrates a case in which the portable terminal 100 performs wireless charging by receiving a wireless power from the charging pad 200. The charging pad 200 generates an induced current in order to supply the wireless power to the portable terminal 100, which generates a powerful magnetic field.

When the magnetic field is generated by the wireless charging, if a user is in proximity of the portable terminal 100 and the charging pad 200, or a part of the user's body, such as a hand, approaches the portable terminal 100 and the charging pad 200, a powerful magnetic field may have a harmful effect on the user's body.

Therefore, the portable terminal 100 and the charging pad 200, according to an embodiment of the present invention, detect whether a human body approaches during the wireless charging. When the human body approaches, the portable terminal 100 and the charging pad 200 stop the wireless charging.

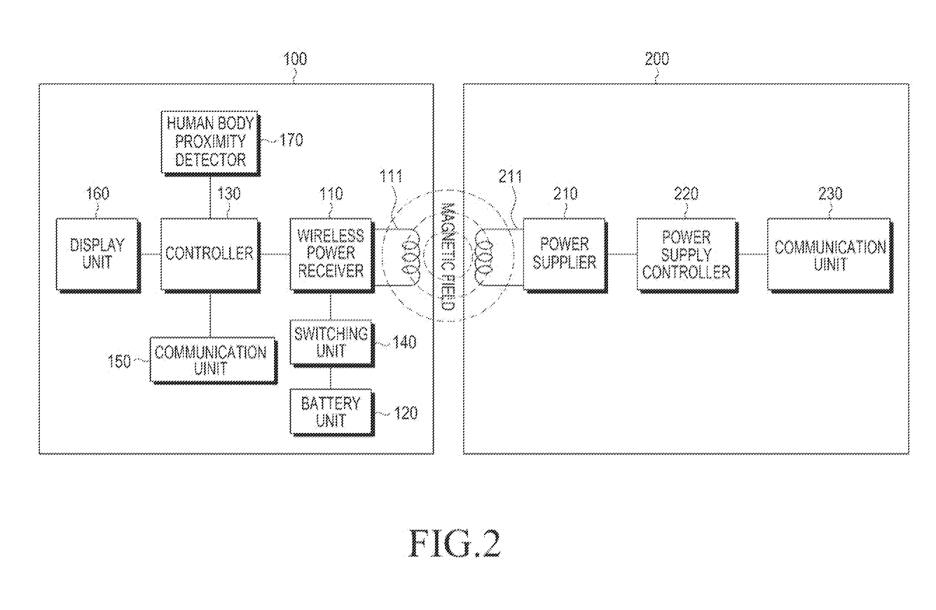

A construction of the portable terminal 100 and the charging pad 200 is described in greater detail below, according to an embodiment of the present invention. FIG. 2 is a block diagram illustrating the construction of the wireless charging apparatus, according to an embodiment of the present invention.

Referring to FIG. 2, the wireless charging apparatus includes the portable terminal 100 and the charging pad 200.

The portable terminal 100 includes a wireless power receiver 110, a battery unit 120, a controller 130, a switching unit 140, a communication unit 150, a display unit 160, and a human body proximity detector 170.

The wireless receiver 110 receives supply power from the charging pad 200 by resonance in the same frequency between a resonant coil 111 of the wireless receiver 110 and a resonant coil 211 of the charging pad 200. The wireless receiver 110 transmits the received power to the battery unit 120.

The battery unit 120 charges a battery using the power received by the power receiver 110. When charging is completed, the battery unit 120 notifies the controller 130 that the charging has been completed.

The controller 130 controls general operations of the portable terminal 100. Particularly, the controller 130 controls general operations for performing wireless charging. The controller 130 determines whether charging is required, by checking the remaining power of the battery unit 120. When the charging is required, the controller 130 controls the display unit 160 to notify that charging is required. In addition, the controller 130 controls the communication unit 150 to transmit a power supply apparatus search signal, and controls the communication unit 150 to transmit a wireless power supply request signal to the charging pad 200, which is known to exist in the proximity of the portable terminal through the reception of a power supply apparatus search response signal through the communication unit 150. Further, the controller 130 receives wireless power from the charging pad 200 by controlling the wireless power receiver 110, and controls performance of charging using the power received from the charging pad 200. When an approaching human body is detected by the human body proximity detector 170, the controller 130 controls transmission of a wireless power supply interruption request signal to the charging pad 200 through the communication unit 150, and controls the switching unit 140 to stop the wireless charging.

The switching unit 140 stops a power charging operation between the battery unit 120 and the wireless power receiver 110, under the control of the controller 130.

The communication unit 150 transmits a signal received from the charging pad 200 to the controller 130 by performing communication with the charging pad 200, under the control of the controller 130. In addition, the communication unit 150 transmits a signal, as requested by the controller 130, to the charging pad 200. The communication unit 150 may be configured by a Near Field Communication (NFC) scheme, such as, for example, by an NFC Integrated Circuit (IC), and may perform communication with the charging pad 200 through an NFC channel.

The display unit 160 may be embodied as a Liquid Crystal Display (LCD) display device, an Organic Light Emitting Diode (OLED) display device, or the like. The display unit 160 displays the remaining power of the battery, or whether charging is required, under the control of the controller 130. Further, the display unit 160 displays a wireless power reception state, a wireless power reception interruption state, a wireless charging state, and state information required to determine whether to perform or stop wireless charging, such as, for example, an approaching human body, under the control of the controller 130.

The human body proximity detector 170 may be configured by a human body detecting sensor. The human body proximity detector 170 detects, in real-time, whether a human body exists in a predetermined space close to the wireless charging apparatus. The human body proximity detector 170 transmits a human body proximity detecting signal, according to a result of the detection to the controller 130. The human body detecting sensor, i.e., the human body proximity detector 170, may use superconducting sensors using an infrared detecting scheme, a temperature detecting scheme, a type detecting scheme, a supersonic wave detecting scheme, or the like.

A construction of the charging pad 200, which is a power supply apparatus for supplying power to the portable terminal 100, is described in detail below.

The charging pad 200 includes a power supplier 210, a power supply controller 220, and a communication unit 230.

The power supplier 210 transmits a supply power through resonance in the same frequency between a resonant coil 111 of the wireless receiver 110 and a resonant coil 211 of the charging pad 200.

The power supply controller 220 generally controls an operation for supplying power to the portable terminal 100. Further, when a wireless power supply apparatus search signal from the portable terminal 100 is received through the communication unit 230, the power supply controller 220 controls transmission of a wireless power supply search response signal, in response to the wireless power supply apparatus search signal. When a power supply request signal is received from the portable terminal 100 through the communication unit 230, the power supply controller 220 controls the power supplier 210 so as to perform a wireless power transmission to the portable terminal 100. When a power supply interruption signal generated from human body proximity detection is received from the portable terminal 100, the power supply controller 220 controls the power supplier 210 to interrupt a wireless power transmission.

The communication unit 230 performs communication with the communication unit 150 of the portable terminal 100, and transmits various signals received from the portable terminal 100 to the power supply controller 220, under the control of the power supply controller 220. The communication unit 230 transmits various signals, the transmission of which is requested by the power supply controller 220, to the portable terminal 100. The communication unit 230 may be configured by an NFC scheme, such as, for example, by an NFC Integrated Circuit (IC), and performs a communication with the portable terminal 100 through an NFC channel.

The charging pad 200 may further include a human body proximity detector. When an approaching human body is detected by the human body proximity detector, the power supply controller 220 controls the power supplier 210 to interrupt a wireless power supply and controls notification of the portable terminal 100 through the communication unit 230, such that the wireless power supply is interrupted due to the approaching human body.

Hereinafter, a process of interrupting a wireless charging operation according to the detection of an approaching human body during wireless charging, by the portable terminal 100 and the charging pad 200, is described in greater detail below.

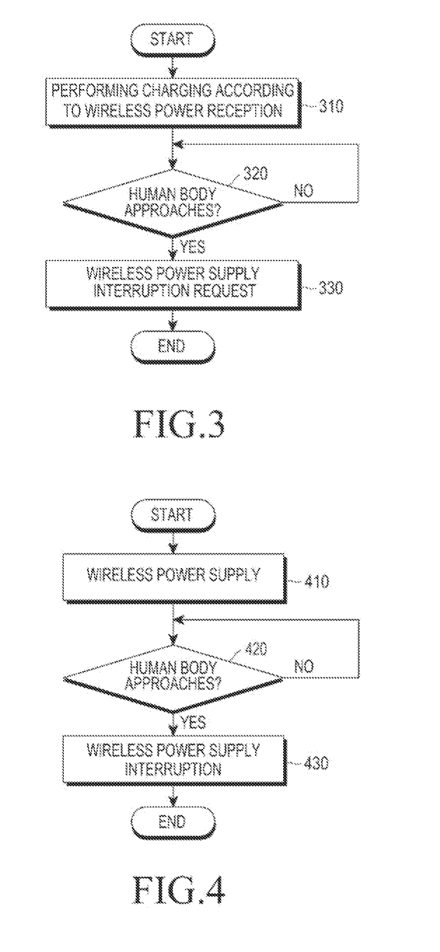

FIG. 3 is a flowchart illustrating a method of receiving wireless power at the portable terminal 100, according to an embodiment of the present invention.

Referring to FIG. 3, in step 310, the portable terminal 100 performs charging by receiving a wireless charging power from the charging pad 200.

In step 320, the portable terminal 100 determines whether a human body approaches, via the human body proximity detector 170. The human body proximity detector 170 may detect whether a human body approaches a predetermined space in proximity to the portable terminal 100 in real-time by using, for example, an infrared detecting scheme, a temperature detecting scheme, a type detecting scheme, a supersonic waves detecting scheme, or the like.

When an approaching human body is detected, the portable terminal 100 transmits a wireless power supply interruption request signal to the charging pad 200 through the communication unit 150 and interrupts wireless charging, in step 330.

Although an embodiment in which the portable terminal 100 interrupts the wireless charging by detecting an approaching human body and transmitting the wireless power supply interruption request to the charging pad 200 has been described above, the charging pad 200 may also interrupt wireless charging by detecting the approaching human body.

FIG. 4 is a flowchart illustrating a method of charging wireless power by the charging pad 200, according to an embodiment of the present invention.

Referring to FIG. 4, in step 410, the charging pad 200 supplies wireless power to the portable terminal 100.

Further, in step 420, the charging pad 200 determines whether a human body approaches via a human body proximity detector. The human body proximity detector may detect whether a human body approaches a predetermined space in proximity to the charging pad 200 in real-time by using, for example, an infrared detecting scheme, a temperature detecting scheme, a type detecting scheme, a supersonic waves detecting scheme, or the like.

When an approaching human body is detected, the charging pad 200 transmits a wireless power supply interruption signal to the portable terminal 100 through the communication unit 230, and interrupts a wireless power supply, in step 430.

In an apparatus and a method for wireless charging, according to embodiments of the present invention, it is possible to prevent a human body from being exposed to a magnetic field by interrupting wireless charging when a human body approaches during wireless charging. Further, in an apparatus and a method for wireless charging, according to embodiments of the present invention, wireless charging is interrupted when a human body approaches during the wireless charging, and the wireless charging is performed when a human body does not approach. As a result, embodiments of the present invention enable continuous wireless charging while preventing a human body from being exposed to a magnetic field.

According to an embodiment of the present invention, the portable terminal is described as an example of the wireless power reception apparatus and the charging pad is described as an example of the wireless power supply apparatus. However, any apparatus that can be wirelessly supplied power can embody the wireless power reception apparatus, and any apparatus that can wirelessly provide power can embody the wireless power supply apparatus.

While the invention has been shown and described with reference to certain embodiments thereof, it will be understood by those skilled in the art that various changes in form and detail may be made therein without departing from the scope of the present invention.

What is claimed is:

1. A method of wireless charging, the method comprising the steps of:
receiving wireless power at a wireless power reception apparatus and performing wireless charging by the wireless power reception apparatus;
determining whether a human body is approaching the wireless power reception apparatus while the wireless power reception power apparatus is receiving the wireless power; and
interrupting the wireless charging, when it is determined that the human body is approaching the wireless power reception apparatus.

2. The method of claim 1, wherein interrupting the wireless charging comprises:
transmitting a wireless power interruption request signal from the wireless power reception apparatus to a wireless power supply apparatus.

3. A method of wireless charging, the method comprising the steps of:
supplying wireless power by a wireless power supply apparatus;
determining whether a human body is approaching the wireless supply reception apparatus while the wireless power supply apparatus is supplying the wireless power; and
interrupting the wireless charging, when it is determined that the human body is approaching the wireless power supply apparatus.

4. The method of claim 3, wherein interrupting the wireless charging comprises:
transmitting a wireless power interruption signal from the wireless power supply apparatus to a wireless power reception apparatus.

5. An apparatus for wireless charging, the apparatus comprising:
a power receiver for receiving a supply power through resonance with a wireless power supply apparatus in a same frequency;
a battery unit that is charged using the supply power;
a switching unit disposed between the power receiver and the battery unit for interrupting a wireless charging operation of the battery unit;
a human body proximity detector for determining whether a human body is approaching the apparatus; and
a controller for wirelessly controlling the power receiver to wirelessly receive power from the power supply apparatus, and for controlling the switching unit to interrupt the wireless charging operation when it is determined that the human body is approaching the apparatus.

6. The apparatus of claim 5, further comprising:
a communication unit for transmitting a power supply interruption request signal to the wireless power supply apparatus.

7. An apparatus for wireless charging, the apparatus comprising:
a power supplier for supplying power to a wireless power reception apparatus by resonance in a same frequency;
a human proximity detector for determining whether a human body is approaching the apparatus; and
a controller for controlling the power supplier to supply power to the wireless power reception apparatus, and for controlling an interruption in supplying the power when it is determined that the human body is approaching the apparatus.

8. The apparatus of claim 7, further comprising:
a communication unit for transmitting a power supply interruption signal to the wireless power reception apparatus.
